(19) United States
(12) Patent Application Publication
(10) Pub. No.: US 2006/0011103 A1
(43) Pub. Date: Jan. 19, 2006

(54) Dry powder coating of metals, oxides and hydroxides thereof

(76) Inventor: Qiping Zhong, Cupertino, CA (US)

Correspondence Address: Paul J. Shannon;Nanomat Inc., 1061 Main St., North Huntingdon, PA, 15642, US

(21) Appl. No.: 10/883,442

(22) Filed: Jul. 1, 2004

(51) Int. Cl. B05D 7/00; C08F 2/46

(52) U.S. Cl. 106/286.1; 427/212; 427/487

(57) ABSTRACT

The present invention is method of making a metal, metal oxide, or metal hydroxide filler composition by dry coating powders with an polymerizable monomers using a coupling agent, preferably an trialkoxysilane, as a covalent linker between the filler and the monomer coating, and inducing polymerization to provide polymer coated particles of the powders. The invention also includes novel compositions comprising metal, metal oxide and hydroxide powders with bonded coupling agent and polymer coatings.

### BACKGROUND OF INVENTION

1. Field of Invention

This invention relates to a novel method for coating or encapsulating minute filler particles with a polymer coating to provide polymer coated filler particles that, for instance, exhibit high electrically insulating properties. In particular, the method calls for polymerization of monomers with functionalized filler particles in a dry flowable state.

2. Description of Related Art

Polymer coated filler particles have several diverse uses. U.S. Pat. No. 6,406,746 describes micro-capsulating conductive metal particles with polymerized monomers as fillers for conductive adhesive agents. When the particles are dispersed in an epoxy type adhesive agent, the resulting medium is electrically insulating. Application of pressure shears the particles and allows the conductive metal particles to meld to give a conducting medium, but only in the area of the shear. These micro-capsulating particles are prepared by a method requiring treatment of metal particles with an affinity agent followed by dispersion of the particles in a solvent containing reactive monomers and allowing the monomers to polymerize on the surface of the particles. The solvent has to be removed before the coated particles can be useful. In a related U.S. Pat. No. 6,080,443, microcapsulating particles are prepared by dispersion of the metal particles in an oil phase and conducting an emulsion polymerization with an aqueous monomer phase. Again the solvents have to be removed.

In U.S. Pat. No. 4,689,250, Quella, et al, describe a filler composition composed of metal particles individually coated with a cross-linked polymer layer that provides high thermal conductivity and high electrical insulation capacity. Such filler composition is useful as an addition to resins employed in injection molding and extrusion. The particles are coated by dispersing the fine particles in a non-aqueous medium or water with an added emulsifier, adding to the dispersion a cross-linking composition and executing a cross-linking polymerization. The Cross-linked coated particles are separated in a medium that does not dissolve such coated polymers.

In U.S. Pat. No. 5,993,967, Brotzman, et al., describe a coated ceramic powder comprising a siloxane star-graft polymer encapsulating various metal oxides thereby enabling the dispersion of such particles in oils, polymers and water. The polymer is distributed on the particles in a high shear dispersion in a solvent followed by separation of the coated particles by dilution with a non-solvent and centrifugation.

In U.S. Pat. No. 6,689,190, Pozarnsky discloses a method of making nanoparticles of metals comprising vaporization of the metal, solidification in a gas stream, coating of the fine particles with reactive gases, including monomers, to provide polymer coated particles, and collecting the particles in an organic solvent phase.

In all the cited references, coating of metal or metal oxide particles is accomplished using a liquid medium to disperse the particles. This allows uniform distribution of polymer but has several drawbacks including the cost of solvents, requirement for high shear mixing equipment, and post-coating processes such as dilution, centrifugation, and further drying of the powders. Avoiding these issues, U.S. Pat. No. 5,595,609, Gay, describes a method for spray coating metal particles with a pre-formed polymer in a solvent in a fluidized bed with concomitant removal of solvent vapors. U.S. Pat. No. 4,073,977, Koester, et al, describes a method for coating metal particles with alkylene oxide gas that provides a polymer coating on the metal particles using a rotary kiln or fluidized bed coating system. The method appears limited in that a large amount of alkylene oxide is used, preferably from 2 to 4 g per g of metal powder. In many applications wherein metal particle weight fraction is to be maximized, this loading of polymer would not be desirable. Herein is described a novel method for coating filler particles referred to as the dry powder microcapsulation method wherein the functionalized filler particles are coated with polymerizable monomer, followed by polymerization, in a dry powder flowable state. This method has significant process advantages in that solvents may or may not be used and thus, several post-processing steps can be avoided. The method allows effective polymer coating of filler particles at low loadings of polymer. Additionally, the method allows coating of filler particles in large volume because the volume fraction of particles to reactor volume may be high, up to 70 volume percent. Thus, the method has significant cost advantages based on little or no post-process steps, simple low-cost process equipment, high volume throughput and minimal or no use of solvents.

### SUMMARY OF THE INVENTION

The present invention provides a method of making a polymer coated filler composition by dry coating filler particles comprising the steps of: providing a plurality of functionalized filler particles comprising a plurality of filler particles with bonded coupling agent, mixing the plurality of functionalized filler particles, in a dry flowable state, with a defined amount of polymerizable monomer and a polymerization catalysis to provide a dry flowable monomer-particle mix, and applying actinic radiation to the dry flowable monomer-particle mix to initiate polymerization and provide a substantially uniform layer of polymer coating onto each of a plurality of functionalized filler particles.

In another embodiment the invention provides a method of making a polymer coated filler composition by dry coating filler particles comprising the steps of: providing a blend of a coupling agent, a defined amount of polymerizable monomer and a polymerization catalysis, mixing said blend with a plurality of filler particles, in a dry flowable state, to provide a dry flowable monomer-particle mix, and applying actinic radiation to the dry flowable monomer-particle mix to initiate bonding of the coupling agent to the plurality of filler particles to provide a plurality of functionalized filler particles, and to initiate polymerization to provide a polymer coating onto each of a plurality of functionalized filler particles.

In another embodiment the invention is a non-conducting metal powder composition consisting essentially of a plurality of metal particles having a functionalized alkyl silane bonded to the plurality of metal particles and about a 2 nm to about 500 nm thick coating of polymer bonded to the functionalized alkyl silane, that when pressed into a 1 inch diameter disc with a top and bottom surface, exhibits no conductivity when two 5 volt leads are applied at 1.5 cm spacing on the top or bottom surface of the disc.

In other embodiments the invention is a metal hydroxide or metal oxide powder composition consisting essentially of a plurality of metal hydroxide or metal oxide particles having a functionalized alkyl silane bonded to the plurality of metal hydroxide or metal oxide particles and about a 2 nm to about 500 nm thick coating of polymer bonded to the functionalized alkyl silane, that when suspended in toluene at a 3 wt % loading exhibits a clear homogenous solution with no apparent precipitate or haziness.

### DETAILED DESCRIPTION OF INVENTION

In the invention “filler particles” refers to particles selected from the group of metal, alloys of metal, metal oxides and metal hydroxides. The pure metals and alloys are preferably provided with an oxide layer. Throughout the application the term “filler particles” is meant to include the whole group. Preferred metals for filler particles are copper, iron, cobalt, vanadium, nickel, silver, gold, aluminum and alloys thereof. Preferred metal oxides are TiO₂, Al₂O₃, ZnO, BaO, iron oxide in the form of γ-Fe₂O₃, α-Fe₂O₃ or Fe₃O₄, and mixtures thereof. Preferred metal hydroxides are aluminum trihydrate and magnesium hydroxide. The diameter of the particles is preferably in the range of from about 5 nm through 100 μm with preference for diameters in the range of about 5 nm to 10 um. Most preferred for applications wherein optical transparency is required are diameters in the range of about 5 nm to about 500 nm. Most preferred metals to practice the invention are selected from the group of copper, silver, iron and nickel. Most preferred metal oxides are the iron oxides γ-Fe₂O₃, α-Fe₂O₃, Fe₃O₄, titanium dioxide and barium titanate. A most preferred metal hydroxide is aluminum trihydrate with an average particle size of about than 100 nm.

“Functionalized filler particles” refers to filler particles that have been functionalized or chemically treated with a coupling agent. The coupling agent acts to modify the surface properties of the particle to enhance wetting of a polymer and/or allow grafting of a polymer onto the particle surface. For the purposes of the invention, coupling agents are of two general classes: Monofunctional coupling agents act to provide bonding to filler particles and change the surface properties of the particles. They may improve the wetting of the particles toward polymer coatings. Ambifunctional coupling agents have two distinct functional groups that may have similar or different reactivities. Ambifunctional coupling agents may provide bonding to both filler particle and polymer coating. Classes of monofunctional and ambifunctional coupling agents useful in the invention include silanes, mercaptans, epoxys, isocyanates and titanates.

Monofunctional silane coupling agents include trialkoxyalkylsilanes, dialkoxyalkylsilanes, monoalkoxyalkyl silanes and chlorodimethylalkylsilanes wherein the alkyl group is a straight chain or branched chain hydrocarbon. Specific examples of these coupling agents are octadecyltrimethoxysilane, octadecyltriethoxysilane, hexadecyltrimethoxysilane, n-hexyltrimethoxysilane, n-propyltrimethoxysilane, dimethoxymethyloctylsilane, dimethoxymethyloctadecylsilane, cyclohexyldimethoxymethylsilane, chlorodimethyloctadecylsilane, chlorodimethyloctylsilane, and chlorodimethylisopropylsilane. Ambifunctional silane coupling agents are trialkoxyalkylsilanes and dialkoxydialkylsilanes wherein the alkyl moiety is functionalized with a reactive group such as vinyl, acryloyl, methacryloyl, amino, epoxy, mercapto, isocyanato and ureido. Specific preferred ambifunctional coupling agents include trimethoxyvinylsilane, triethoxyvinylsilane, allyltriethoxysilane, 3-aminopropyltrimethoxysilane, 3-aminopropyltriethoxysilane, 3-glycidoxypropyltrimethoxysilane, 3-methacryloyloxypropyltrimethoxysilane, 3-glycidoxypropyltriethoxysilane, 3-methacryloyloxypropyltriethoxysilane, 3-mercaptopropyltrimethoxysilane, 3-isocyanatopropyltrimethoxysilane and 3-ureidopropyltrimethoxysilane. The monofunctional and ambifunctional silanes are preferred coupling agents for filler particles with oxide coatings.

Monofunctional mercaptan coupling agents include alkyl and arylalkyl mercaptans. Specific examples of these coupling agents are 2,5-thiophenol, 3,5-thiophenol, 4-ethylthiophenol, 4-octylthiophenol, 4-octadecylthiophenol, 1-octanethiol, 1-decanethiol, 1-hexadecanethiol, and 1 -octadencanethiol. Ambifunctional mercaptan coupling agents are alkyl and arylalkyl mercaptans wherein the alkyl and arylalkyl moiety is functionalized with a reactive group such as vinyl, allyl, acryloyl, methacryloyl, amino, epoxy, and ureido. Specific examples include 4-vinylthiophenol, 4-allylthiophenol, 4-gylcidyloxythiophenol, gylcidyl 2-mercaptoacetate, gylcidyl 3-mercaptopropionate, 4-ureidothiophenol, 4-aminothiophenol, 4-aminophenyl 2-mercaptoacetate, and 4-vinylphenyl 2-mercaptoacetate. The monofunctional and ambifunctional mercaptans are preferred coupling agents for gold particles.

Monofunctional epoxy coupling agents include alkyl and arylalkyl epoxys. Specific examples of these coupling agents are ethylene oxide, propylene oxide 4-gylcidyloxyoctylbenzene, 4-gylcidyloxyoctadecylbenzene, 4-gylcidyloxyoctadecane, and 4-gylcidyloxydecane. Ambifunctional epoxy coupling agents are alkyl and arylalkyl epoxys wherein the alkyl and arylalkyl moiety is functionalized with a reactive group such as vinyl, allyl, acryloyl, methacryloyl, amino, mercapto, isocyanato and ureido. Specific examples include 4-gylcidyloxyvinylbenzene, 4-gylcidyloxyallylbenzene, glycidylmethacrylate, glycidyl 2-mercaptoacetate, gylcidyl acrylate, and 3-gylcidyloxypropylisocyanate. The epoxy coupling agents are preferred for use with metal oxide particles.

Monofunctional isocyanate coupling agents include alkyl and arylalkyl isocyanates. Specific examples of these coupling agents are hexyl isocyanate, decyl isocyanate, hexadecylisocyanate, and octadecyl isocyanate.

Ambifunctional isocyanates coupling agents are alkyl and arylalkyl isocyanates wherein the alkyl and arylalkyl moiety is functionalized with a reactive group such as vinyl, acryloyl, methacryloyl, amino, epoxy, mercapto, isocyanato and ureido. Specific examples include 2-isocyanatoethyl methacrylate, 4-allyloxyisocyanatobenezene, 4-vinylisocyanatobenzene. Disocyanates may be used as precursors to ambifunctional isocyanates as well. Initial coupling of the metal surface with excess diisocyanate may give an isocyanate rich surface. The isocyanate rich surface may be treated with polymerizable monomers directly or it may be treated with hydroxy containing functional groups to provide a variety of functionalized metal particles. Examples of disiocyanates useful in this approach include toluene diisocyanate, isophorone diisocyanate, and 1,6-hexane diisocyanate. Examples of hydroxy containing functional groups include 2-hydroxyethyl methacrylate, hydroxy terminated polybutadiene, hydroxy terminated polyesters, polyols and the like.

In one embodiment of the invention the functionalized filler particles may be provided from any source or method, provided that the coupling agent is bonded to the filler particles and the particles are in a dry flowable state.

In another embodiment the functionalized filler particles may be provided by mixing filler particles, in the dry flowable state, with a coupling agent to give an adsorbed coupling agent-filler particle. The adsorbed coupling agent-filler particle may be further treated by applying actinic radiation to initiate bonding to the filler particle or the adsorbed coupling agent may undergo bonding without additional treatment. The resulting functionalized filler particles are suitable for use in the polymer coating step. The coupling agent may be added to the filler particles in a liquid form, either as a pure liquid or as a concentrated solution using a solvent as a carrier. Almost any aqueous or organic solvents may be suitable as a carrier but solvents with boiling points less than about 120° C., and more preferably less than 100° C., are preferred. Specific solvents that are useful include water, methanol, ethanol, isopropanol, acetone, methyl ethyl ketone, tetrahydrofuran, ethyl ether, methyl isobutyl ether, ethyl acetate, methyl acetate, dimethoxyethane, toluene, benzene, hexanes, heptanes, dichloromethane, chloroform, 1,2-dichloroethane and mixtures thereof.

In practicing the invention in general about 0.5 to about 2.0 wt % coupling agent may be used based on the weight of the filler particles to be functionalized. For particles with less than 50 m²/g SSA, about 0.5% to about 1 wt % of coupling agent may be used. However, the artisan will recognize that the amount of coupling agent required to attain complete monolayer coverage of the particles is dependent upon the specific surface area (SSA) of the particles to be functionalized and the surface area coverage (SAC) of the coupling agent. The SAC is usually specified in vendor catalogues that offer coupling agents. Suppliers of coupling agents useful in the invention include General Electric SiO, Inc, DeGussa, Inc. and Dow Corning, Inc. The following equation may be used to determine the amount of coupling agent for nominal monolayer surface coverage:

$$Wt \% coupling agent = \frac{SSA {m}^{2} \text{/} g}{SAC {m}^{2} \text{/} g} \times 100 \%$$

The filler particles can be of most any mesh or grain size and have a wide range of SSA to practice the invention. However, a general preferred particle size for the invention is in the range of 5 nm to about 10 μm. The invention is especially suitable for coating larger particles sizes, for instance, between about 100 nm and 10 μm that usually are more difficult to coat in gas suspension or liquid suspensions.

In the invention, “Mixing the functionalized filler particles, in a dry flowable state, with a defined amount of polymerizable monomer” the term “dry flowable state” means the filler particles maintain the consistency of a flowable powder, thus, allowing the monomer to disperse uniformily over the particles. To maintain this dry flowable state, the adding and mixing of monomer has to be carefully controlled as exemplified in the Examples.

“Polymerizable monomer” refers to any reactive organic material that may provide a polymer upon polymerization with itself or other monomers and includes monomers, cross-linkers, oligomers, and macro-monomers within the families of addition, condensation and ring-opening polymerization monomers. The monomers may be solids, liquids or gases. Preferred liquid monomers have viscosities less than about 300 cps at RT and, more preferably, viscosities of less than about 100 cps. Most preferred are monomers with viscosities between about 1 and 20 cps at RT. Solvents may be used to as a carrier solvent for solid or high viscosity monomers. Preferred solvents are organic solvents including hydrocarbons, chlorinated hydrocarbons, esters, ethers, ketones, and alcohols with boiling points below 120° C. and preferably below 100° C. Specific solvents listed earlier are appropriate as carriers for the polymerizable monomers.

Addition monomers are preferred in the invention and include acrylic, methacrylic, vinyl, styryl, and unsaturated polyesters. Most preferred addition monomer classes are acrylic, methacrylic and styryl monomers. Specific examples of acrylic and methacrylic addition monomers useful in the invention include monomer(s) chosen from pentaerythritol di-, tri- and tetra-acrylates, pentaerythritol di, tri- and tetra-methacrylates, butanediol dimethacrylate, hexanediol dimethacrylate, nonanediol dimethacrylate, diethylene glycol dimethacrylate, triethylene glycol dimethacrylate, poly(oxyalkylene dimethacrylates), e.g., polyethylene glycol (600) dimethacrylate, ethoxylated bisphenol A dimethacrylate monomers, ethylene glycol bismethacrylate, polyhydric alcohol polyacrylate monomers, such as trimethylol propane trimethacrylate, alkoxylated polyhydric alcohol polyacrylate monomers, such as ethoxylated trimethylol propane triacrylate monomers, urethane acrylate monomers, such as those described in U.S. Pat. No. 5,373,033, C₁ to C₁₂ alkyl methacrylates, such as methyl methacrylate, alkoxylated phenol methacylates; polyol[(meth)acryloly terminated carbonate]monomer, acrylated oligomers of epoxies, urethanes, acrylics and polyester and mixtures thereof. Specific preferred addition monomers are methyl methacrylate (MMA), styrene, vinyl acetate and divinylbenzene (DVB) and mixtures thereof. More preferred addition monomers for practicing the invention are MMA and DVB and mixtures thereof. As exemplified in the Examples mixtures of monomers often are preferred to obtain specific properties. The most preferred polymerizable monomer composition is a blend of methyl methacrylate and divinylbenzene in a weight ratio of about 2 to 1 to about 8 to 1, respectively.

Within condensation monomers, families selected from the group of diisocyanates, dianhydrides, diamines, polyols, polyesters, polyacids and their chlorides, polyamines and polyalkoxyalkylsilanes may be useful in the invention.

The “defined amount” of polymerizable monomer to be used may be calculated by estimating or measuring the specific surface area of the functionalized metal particles to be coated and selecting a nominal polymer coating thickness. The following equation may be used:
Amt. particles (g)×SSA (m²/g)×thickness(m)×10⁶cc/m³×density monomer (g/cc)=Amt. monomer (g)

In the invention, a polymer coating thickness in the range of about 2 nm to about 50 nm is preferred, with a range of about 5 nm to about 30 nm more preferred and a range of about 10 nm to about 20 nm is most preferred.

By “applying actinic radiation to initiate polymerization” we mean to apply any step and/or polymerization catalysis that functions to polymerize the monomer in the presence of the functionalized metal particles in a dry flowable state. The artisan will recognize that the specific method and/or polymerization catalysis to be used may be dependent upon the specific coupling agent used in the functionalization of the filler particles and the monomer to be used. Actinic radiation refers to any form of radiation that may be used to induce bond formation and/or cross-linking. Forms of actinic radiation include ultraviolet (e.g. lamps and lasers), infrared (lamps, lasers, radiant heat sources, ovens etc.), visible (lamps, lasers) microwave, e-beam, and conventional heating methods.

The polymerization catalysis may be any of a wide variety of acids, bases, radical initiators that are normally used to initiate polymerizations. For example, addition polymerizations are initiated by application of some form of actinic radiation in the presence of a free radical initiator. Radical initiators may be added at about 0.1 to about 5 weight % based on the amount of monomer. A preferred method of addition is to add the radical initiator to the liquid monomer phase. Radical initiators useful to polymerize addition type monomers include the dialkylazo initiators such as 2,2′-azobisisobutylnitrile (AIBN), and organic peroxides including acyl peroxides such as dibenzoyl peroxide, bis(4-chlorobenzoyl) peroxide, bis(2,4-dichlorobenzoyl) peroxide and bis(4-methylbenzoyl) peroxide; alkyl peroxides and aryl peroxides such as di-t-butyl peroxide, 2,5-bis(t-butylperoxy)-2,5-dimethylhexane, dicumyl peroxide and 1,3-bis(t-butylperoxyisopropyl)benzene; and mixtures thereof.

Initiation of polymerization is accomplished preferably by heating the mixture of monomer, initiator and functionalized filler particles in a dry flowable state. Other means of applying actinic radiation, such as listed above, may also be used to initiate polymerization. The artisan will recognize that a wide variety of radical initiators and methods for introducing them to the process are available and the invention is not limited to any specific approach or reagent.

Another preferred embodiment of the invention is an in situ coupling method wherein a coupling agent and a defined amount of polymerizable monomer are mixed to provide a blend. Mixing of the blend with filler particles, in a dry flowable state, provides a dry flowable mix. Actinic radiation is applied to the dry flowable mix to both initiate bonding of the coupling agent to the filler particles to provide functionalized filler particles, and, initiate polymerization to provide a polymer coating on the functionalized filler particles. All the aforementioned issues and preferences regarding selection and amounts of coupling agent, polymerizable monomer, polymerization initiator, coating thickness and actinic radiation apply to this preferred embodiment, and other composition embodiments described below, as well.

The invention may be performed under a wide variety of temperatures, and pressures, and in the presence of a wide variety of gas environments. Usually a temperature range of from 20 to 110° C. is the preferred, but higher temperatures may be used in specific circumstances. Pressures used in the method may vary, but usually range from 20 mm Hg to about 800 mm Hg, and preferably about 1 atmosphere. A variety of gases may be used to blanket the metal particles and/or act as a carrier for monomers including air, nitrogen, argon, and helium. Reactor configurations may vary widely depending upon the volume of material to be coated. In general the method may be applied to both batch and continuous processes. For batch processes a rotary kiln is a suitable reactor for both functionalization of metal particles and the polymer coating process. A preferred reactor configuation is a V-Blender, for instance, that manufactured by Patterson-Kelley. For continuous processes a fluidized bed coating system may be used wherein material addition ports and actinic radiation sources are positioned along a translating fluidized bed.

The method of the invention is especially useful for coating filler particles wherein the filler particles are of a relatively large size, for instance, 10 μm to about 100 μm. In addition, the method is capable of producing thin polymer coatings, for instance, in the range of 5 nm to about 50 nm. Thus, the volume of filler to polymer ratio may be very high. These features combined with the volume fraction of particles to reactor volume available in some reactor configurations, allows for the production of large volumes of polymer coated metal particles using the method of the invention.

Another embodiment of the invention is a non-conducting metal powder composition consisting essentially of a plurality of metal particles having a functionalized alkyl silane bonded to the plurality of metal particles and about a 2 nm to about 500 nm thick coating of polymer bonded to the functionalized alkyl silane, that when pressed into a 1 inch diameter disc, exhibits no conductivity when 5 volt leads are applied at 1.5 cm spacing to the top or bottom surface of the disc. Preferred metals for this composition are copper, iron, cobalt,. vanadium, nickel, silver, gold, aluminum and alloys thereof. Preferably the coating of polymer is about 2 nm to about 500 nm thick and more preferred is a coating of about 2 nm to 50 nm thick. Preferably the functionalized alkyl silane is derived from reaction of trialkoxyvinyl silane with the metal particle surface and more preferably the functionalized alkyl silane is derived from reaction of trimethoxyvinyl silane with the metal particle surface. The coating of polymer on the metal particles is preferably an addition polymer and more preferably the addition polymer is selected from the group: polymer or copolymer derived from polymerization of methyl methacrylate, vinyl acetate, styrene, divinylbenzene or mixtures thereof.

Particles comprising predominately metal such as copper, silver and nickel, are useful as fillers in plastics for electro-magnetic interference (EMI) shielding of electronic devices. In such applications high thermal conductivity and high electrical insulating properties are required. In characterization of polymer coated particles comprising predominately metal, the electrical resistivity, or the lack of connectivity, is an important attribute. One method to determine the connectivity is to pelletize the polymer coated particles and apply a voltage across the gap, for instance about 1.5 cm, between leads on the pellet. A lack of connectivity indicates that the pellet is non-conductive.

Aluminum metal particles passivated toward oxidation are important materials in propellant and explosive formulations. Pure aluminum particles are very reactive toward oxidation and have to be protected from unwanted oxidation either by a controlled oxidation with a limited oxygen source or by coating of the particles with a protective layer. Polymers and hydrocarbons often have been used to coat aluminum particles. The invention offers a method for producing polymer coated aluminum particles for use in propellants and explosives.

The use of powdered iron metal and its alloys, is known for forming magnets, such as soft magnetic AC cores for transformers, inductors, motors, generators, and relays. Very fine iron powders are also used in magnetic recording media. In both applications the fine iron powder has to be protected from oxidation. The invention offers a method for producing polymer coated iron particles for use in soft magnetic AC cores and in magnetic recording media.

Another embodiment of the invention is a metal hydroxide powder composition consisting essentially of a plurality of metal hydroxide particles having a functionalized alkyl silane bonded to the plurality of metal hydroxide particles and about a 2 nm to about 500 nm thick coating of polymer bonded to the functionalized alkyl silane, that when suspended in toluene at a 3 wt % loading exhibits a clear homogenous solution with no apparent precipitate or haziness. Preferred metal hydroxides for this composition are aluminum hydroxide and magnesium hydroxide. Preferably the coating of polymer is about 2 nm to about 500 nm thick and more preferred is a coating of about 2 nm to 50 nm thick. Preferably the functionalized alkyl silane is derived from reaction of trialkoxyvinyl silane with the metal hydroxide surface and more preferably the functionalized alkyl silane is derived from reaction of trimethoxyvinyl silane with the metal hydroxide particle surface. The coating of polymer on the metal hydroxide particles is preferably an addition polymer and more preferably the addition polymer is selected from the group: polymer or copolymer derived from polymerization of methyl methacrylate, vinyl acetate, styrene, divinylbenzene or mixtures thereof.

Particles comprising metal hydroxides are useful as fire retardants in filled polymer compositions. Particularly important are very small particles, about 5 nm to about 500 nm, that are transparent in the visible region. One preferred example is polymer coated aluminum hydroxide nano-particles that exhibit good transparency and are easily wetted in filled polymer compositions comprising poly(ethylene) terephthlate (PET) and other polyester compositions.

Another embodiment of the invention is a metal oxide powder composition consisting essentially of a plurality of metal oxide particles having a functionalized alkyl silane bonded to the plurality of metal oxide particles and about a 2 nm to about 500 nm thick coating of polymer bonded to the functionalized alkyl silane, that when suspended in toluene at a 3 wt % loading exhibits a clear homogenous solution with no apparent precipitate or haziness. Preferred metal oxides for this composition are selected from the group TiO₂, Al₂O₃, ZnO, BaO, iron oxide in the form of γ-Fe₂O₃, α-Fe2O₃ or Fe₃O₄, and mixtures thereof. Most preferred metal oxides are barium titanate, iron oxide and aluminum oxide. Preferably the coating of polymer is about 2 nm to about 500 nm thick and more preferred is a coating of about 2 nm to 50 nm thick. Preferably the functionalized alkyl silane is derived from reaction of trialkoxyvinyl silane with the metal oxide surface and more preferably the functionalized alkyl silane is derived from reaction of trimethoxyvinyl silane with the metal oxide surface. The coating of polymer on the metal oxide particles is preferably an addition polymer and more preferably the addition polymer is selected from the group: polymer or copolymer derived from polymerization of methyl methacrylate, vinyl acetate, styrene, divinylbenzene or mixtures thereof.

Particles comprising metal oxides are useful as pigments, spacers for semiconductors and electronic boards and capacitor separators. In such applications the ease of dispersion of metal oxides in an organic polymer matrix is an important attribute.

The following examples are meant to illustrate the invention and are not meant to limit the scope of the invention.

### EXAMPLE 1

The following example describes the procedure for dry coating copper particles to give polymer coated metal particles that are electrically insulating.

In a flask were combined 2.0 g Silquest A-171 trimethoxyvinyl silane, methanol (7.5 g) and water (0.5 g). The mixture was mixed and allowed to stand for 1 h. To a separate flask was added copper powder (250 g) and the flask mounted on a rotating hollow shaft. The silane solution was added drop-wise to the tumbling copper powder over 10 min at RT, followed by continued tumbling for 0.5 h. The resulting powder was dried for 4 h at 100° C. to produce functionalized metal powder. Any clumps were broken up into a powder.

A solution containing 2,2′-azobisisobutylnitrile (0.5 g, AIBN), distilled methyl methacrylate (MMA, 8.0 g) and divinylbenzene (DVN, 2.0 g) was added drop-wise to the functionalized metal powder, while tumbling, over 10 min at RT. The powder was heated and tumbled for 6 h at 90° C. The resulting polymer coated copper powder was passed through a 100-mesh screen.

The polymer coated copper powder (3.0 g) was press into a pellet (1 inch diameter) and tested for conductivity by applying 5 V to the pellet using a Motorola Power Supply TEK23 across 1.5 cm separating leads. Current flow was not detected indicating a lack of connectivity.

### EXAMPLE 2

This example illustrates the in situ coupling method wherein a coupling agent and a defined amount of polymerizable monomer are mixed to provide a blend.

In a flask were combined MMA (8.0 g), AIBN (0.5 g), and DVB (2.0 g). The mixture was stirred until all solids were dissolved. Silquest A-171 (2.0 g) was then added to the mixture. To a separate flask was added copper powder (250 g) and the flask was mounted on a rotating hollow shaft. The silane/monomer solution was added drop-wise to the tumbling copper powder over 10 min at RT, followed by continued tumbling for 0.5 h at RT. The powder was then heated and tumbled for 6 h at 90° C. The resulting polymer coated copper powder was passed through a 100-mesh screen. The polymer coated copper powder (3.0 g) was pressed into a pellet (1 inch diameter). The pellet was found to be non-conducting.

### EXAMPLE 3

This example illustrates the in situ coupling method for coating of iron-cobalt powder.

In a flask were combined MMA (1.4 g), AIBN (0.1 g), and DVB (0.6 g). The mixture was stirred until all solids were dissolved. Silquest A- 171 (1.0 g) was then added to the mixture. To a separate flask was added iron-cobalt alloy powder (20 g, containing 44 wt % cobalt) and the flask was mounted on a rotating hollow shaft. The silane/monomer solution was added drop-wise to the tumbling iron-cobalt alloy powder over 10 min at RT, followed by continued tumbling for 0.5 h at RT. The powder was then heated and tumbled for 3.5 h at 90° C. The resulting polymer coated iron-cobalt alloy powder was passed through a 100-mesh screen. The polymer coated iron-cobalt alloy powder (3.0 g) was pressed into a pellet (1 inch diameter). The pellet was non-conducting.

### EXAMPLE 4

To a round bottom flask was added aluminum trihydroxide powder (ATH, 100 g, about 100 nm average particle size, SSA of about 80 m²/g) and the flask mounted on a rotating hollow shaft. A solution of Silquest A-171 (2.0 g), AIBN (0.5 g), distilled MMA (8.0 g) and DVB (2.0 g) was added drop-wise to the powder, while tumbling, over 10 min at room temperature. Tumbling was continued for 0.5 h at room temperature followed by heating to 90° C. for 6 h. The resulting powder, surface coated with polymer, dispersed in toluene to give a clear homogenous solution with no apparent precipitate or haziness. A control sample of ATH gave an opaque white suspension from which a white solid precipitated.

### EXAMPLE 5

To a flask was added barium titanate powder (100 g, about 70 nm average particle size, SSA of about 100 m²/g) and the flask mounted on a rotating hollow shaft. A solution of Silquest A-171 (2.0 g), AIBN (0.5 g), distilled MMA (8.0 g) and DVB (2.0 g) was added drop-wise to the powder, while tumbling, over 10 min at room temperature. Tumbling was continued for 0.5 h at room temperature followed by heating to 90° C. for 6 h. The resulting powder, surface coated with polymer, dispersed in toluene to give a clear homogenous solution with no apparent precipitate or haziness. A control sample of untreated barium titanate gave an opaque white suspension from which a white solid precipitated.

### EXAMPLE 6 (Comparative)

This example illustrates that a coated polymer sample prepared without using a coupling agent, as required of the invention, fails to give a non-conducting polymer powder.

In a flask were combined AIBN (0.1 g), distilled MMA (0.8 g) and DVB (0.2 g). The mixture was shaken to dissolve the solid AIBN. In a separate flask was added copper powder (25 g) and the flask mounted on a rotating hollow shaft. The monomer was added drop-wise to the tumbling copper powder over 10 m at room temperature. The powder was heated and tumbled for 6 h at 90° C.

The treated powder (3.0 g) was pressed into a pellet (1 inch diameter) and tested for conductivity by applying 5 V to the pellet across 1.5 cm separating leads. Current flow was detected indicating full connectivity.

While particular elements, embodiments and applications of the present invention have been shown and described, it will be understood that the invention is not limited thereto since modifications may be made by those skilled in the art, particularly in light of the foregoing teachings. It is therefore contemplated by the appended claims to cover such modifications as incorporate those features that come within the spirit and scope of the invention.

What I claim is:

1. A method of making a polymer coated filler composition by dry coating filler particles comprising the steps of:
providing a plurality of functionalized filler particles comprising a plurality of filler particles with bonded coupling agent,
mixing the plurality of functionalized filler particles, in a dry flowable state, with a defined amount of polymerizable monomer and a polymerization catalysis to provide a dry flowable monomer-particle mix, and
applying actinic radiation to the dry flowable monomer-particle mix to initiate polymerization and provide a substantially uniform layer of polymer coating onto each of a plurality of functionalized filler particles.

2. A method of claim 1 wherein providing a plurality of functionalized filler particles comprises:
mixing a plurality of filler particles, in the dry flowable state, with a coupling agent to give an a plurality of adsorbed coupling agent-filler particles,
applying actinic radiation to the plurality of adsorbed coupling agent-filler particles to initiate bonding to provide a plurality functionalized filler particles.

3. A method of claim 1 wherein said polymer coating is about 2 nm to about 50 nm in thickness.

4. A method of claim 2 wherein the coupling agent is a functionalized trialkoxyalkylsilane.

5. A method of claim 4 wherein the functionalized trialkoxyalkylsilane is trimethoxyvinylsilane.

6. A method of claim 1 wherein the functionalized filler particles comprise filler particles selected from the group copper, iron, cobalt, vanadium, nickel, silver, gold, aluminum and alloys thereof.

7. A method of claim 1 wherein the functionalized filler particles comprise metal oxide particles selected from the group of TiO₂, Al₂O₃, ZnO, BaO, iron oxide in the form of γ-Fe₂O₃, α-Fe₂O₃ or Fe₃O₄, and mixtures thereof.

8. A method of claim 1 wherein the functionalized filler particles comprise metal hydroxide particles selected from the group of aluminum hydroxide and magnesium hydroxide.

9. A method of claim 1 wherein the polymerizable monomer is an addition monomer selected from the group: of acrylic, methacrylic, vinyl, styryl, and unsaturated polyesters.

10. A method of claim 9 wherein the polymerizable monomer is selected from the group: methyl methacrylate, styrene, vinyl acetate and divinylbenzene and mixtures thereof.

11. A method of claim 10 wherein the polymerizable monomer is a blend of methyl methacrylate and divinylbenzene in a weight ratio of about 2 to 1 to about 8 to 1, respectively.

12. A method of claim 1 wherein the polymerization catalysis is a radical initiator selected from the group: 2,2′-azobisisobutylnitrile, dibenzoyl peroxide, dicumyl peroxide and di-t-butyl peroxide.

13. A method of claim 1 wherein applying actinic radiation comprises heating the dry flowable monomer-particle mix.

14. A method of claim 1 wherein the defined amount of polymerizable monomer is about 0.5 to about 10 wt % of the functionalized metal particles.

15. A method of claim 1 wherein the functionalized filler particles comprise copper particles; the polymerizable monomer is a blend of methyl methacrylate and divinylbenzene in a wt ratio of 4:1; the polymerization catalysis is 2,2′-azobisisobutylnitrile and applying actinic radiation to the dry flowable monomer-particle mix comprises heating the dry flowable monomer-particle mix.

16. A method of making a polymer coated filler composition by dry coating filler particles comprising the steps of:
providing a blend of a coupling agent, a defined amount of polymerizable monomer and a polymerization catalysis,
mixing said blend with a plurality of filler particles, in a dry flowable state, to provide a dry flowable monomer-particle mix, and
applying actinic radiation to the dry flowable monomer-particle mix to initiate bonding of the coupling agent to the plurality of filler particles to provide a plurality of functionalized filler particles, and to initiate polymerization to provide a polymer coating onto each of a plurality of functionalized filler particles.

17. A method of claim 16 wherein said polymer coating is about 2 nm to about 50 nm in thickness.

18. A method of claim 16 wherein the filler particles are selected from the group: copper, iron, cobalt, vanadium, nickel, silver, gold, aluminum and alloys thereof.

19. A method of claim 16 wherein the functionalized filler particles comprise metal oxide particles selected from the group of TiO₂, Al₂O₃, ZnO, BaO, iron oxide in the form of γ-Fe₂O₃, α-Fe₂O₃ or Fe₃O₄, and mixtures thereof.

20. A method of claim 16 wherein filler particles comprise metal hydroxide particles selected from the group of aluminum hydroxide and magnesium hydroxide.

21. A method of claim 16 wherein the polymerizable monomer is an addition monomer selected from the group: of acrylic, methacrylic, vinyl, styryl, and unsaturated polyesters.

22. A method of claim 16 wherein the polymerizable monomer is selected from the group: methyl methacrylate, styrene, vinyl acetate and divinylbenzene and mixtures thereof.

23. A method of claim 22 wherein the polymerizable monomer is a blend of methyl methacrylate and divinylbenzene in a weight ratio of about 2 to 1 to about 8 to 1, respectively.

24. A method of claim 16 wherein the polymerization catalysis is a radical initiator selected from the group: 2,2′-azobisisobutylnitrile, dibenzoyl peroxide, dicumyl peroxide and di-t-butyl peroxide.

25. A method of claim 16 wherein applying actinic radiation comprises heating the dry flowable monomer-particle mix.

26. A method of claim 16 wherein the functionalized metal particles comprise copper particles; the polymerizable monomer is a blend of methyl methacrylate and divinyl benzene in a wt ratio of 4:1; the polymerization catalysis is 2,2′-azobisisobutylnitrile and applying actinic radiation to the dry flowable monomer-particle mix comprises heating the dry flowable monomer-particle mix.

27. A non-conducting metal powder composition consisting essentially of a plurality of metal particles having a functionalized alkyl silane bonded to the plurality of metal particles and about a 2 nm to about 500 nm thick coating of polymer bonded to the functionalized alkyl silane, that when pressed into a 1 inch diameter disc with a top and bottom surface, exhibits no conductivity when two 5 volt leads are applied at 1.5 cm spacing on the top or bottom surface of the disc.

28. A non-conducting metal powder composition of claim 27 wherein the plurality of metal particles consists of copper, iron, cobalt, vanadium, nickel, silver, gold, aluminum and alloys thereof.

29. A non-conducting metal powder composition of claim 28 wherein the metal powder is an iron-cobalt alloy consisting of about 30 to about 70 wt % cobalt and the remainder iron.

30. A non-conducting metal powder composition of claim 28 wherein the metal powder is copper.

31. A non-conducting metal powder composition of claim 28 wherein the metal powder is iron.

32. A non-conducting metal powder composition of claim 28 wherein the metal powder is cobalt.

33. A non-conducting metal powder composition of claim 27 wherein the coating of polymer is about 2 nm to about 50 nm thick.

34. A non-conducting metal powder composition of claim 27 wherein the functionalized alkyl silane is derived from reaction of trialkoxyvinyl silane with the metal particle surface and the polymer is an addition polymer.

35. A non-conducting metal powder composition of claim 34 wherein the trialkoxyvinyl silane is trimethoxyvinyl silane.

36. A non-conducting metal powder of claim 34 wherein the addition polymer is a polymer or copolymer derived from polymerization of methyl methacrylate, vinyl acetate, styrene, divinylbenzene or mixtures thereof.

37. A non-conducting metal powder of claim 27 wherein the plurality of metal particles is copper, the functionalized alkyl silane is derived from reaction of trimethoxyvinyl silane with the plurality of copper particles and the coating of polymer bonded to the functionalized alkyl silane is a derived from polymerization of a mixture of methyl methacrylate and divinyl benzene.

38. A metal hydroxide powder composition consisting essentially of a plurality of metal hydroxide particles having a functionalized alkyl silane bonded to the plurality of metal hydroxide particles and about a 2 nm to about 500 nm thick coating of polymer bonded to the functionalized alkyl silane, that when suspended in toluene at a 3 wt % loading exhibits a clear homogenous solution with no apparent precipitate or haziness.

39. A metal hydroxide powder of claim 38 wherein the coating of polymer is about 2 nm to about 50 nm thick.

40. A metal hydroxide powder of claim 38 wherein the functionalized alkyl silane is derived from reaction of trialkoxyvinyl silane with the metal hydroxide particle surface and the polymer is an addition polymer.

41. A metal hydroxide powder of claim 40 wherein the trialkoxyvinyl silane is trimethoxyvinyl silane.

42. A metal hydroxide powder of claim 40 wherein the addition polymer is a polymer or copolymer derived from polymerization of methyl methacrylate, vinyl acetate, styrene, divinylbenzene or mixtures thereof.

43. A metal hydroxide powder of claim 38 wherein the metal hydroxide is aluminum hydroxide.

44. A metal hydroxide powder of claim 38 wherein the metal hydroxide is magnesium hydroxide.

45. A metal oxide powder composition consisting essentially of a plurality of metal oxide particles having a functionalized alkyl silane bonded to the plurality of metal oxide particles and about a 2 nm to about 500 nm thick coating of polymer bonded to the functionalized alkyl silane, that when suspended in toluene at a 3 wt % loading exhibits a clear homogenous solution with no apparent precipitate or haziness.

46. A metal oxide powder of claim 45 wherein the coating of polymer is about 2 nm to about 50 nm thick.

47. A metal oxide powder of claim 45 wherein the functionalized alkyl silane is derived from reaction of trialkoxyvinyl silane with the metal oxide particle surface and the polymer is an addition polymer.

48. A metal oxide powder of claim 47 wherein the trialkoxyvinyl silane is trimethoxyvinyl silane.

49. A metal oxide powder of claim 47 wherein the addition polymer is a polymer or copolymer derived from polymerization of methyl methacrylate, vinyl acetate, styrene, divinylbenzene or mixtures thereof.

50. A metal oxide powder of claim 45 wherein the metal oxide is selected from the group TiO₂, Al₂O₃, ZnO, BaO, iron oxide in the form of γ-Fe₂O₃, α-Fe₂O₃ or Fe₃O₄, and mixtures thereof.

51. A metal oxide powder of claim 50 wherein the metal oxide is barium titanate.

52. A metal oxide powder of claim 50 wherein the metal oxide is aluminum oxide.

53. A metal oxide powder of claim 50 wherein the metal oxide is iron oxide in the form of γ-Fe₂O₃, α-Fe₂O₃ or Fe₃O₄, and mixtures thereof.
